(19) United States
(12) Patent Application Publication
(10) Pub. No.: US 2011/0067023 A1
(43) Pub. Date: Mar. 17, 2011

(54) SOFTWARE MANAGEMENT APPARATUS, SOFTWARE DISTRIBUTION SERVER, SOFTWARE DISTRIBUTION SYSTEM, AND SOFTWARE INSTALLATION METHOD

(76) Inventors: Naoki CHIYO, Kanagawa (JP); Masami Nasu, Kanagawa (JP)

(21) Appl. No.: 12/877,374

(22) Filed: Sep. 8, 2010

(30) Foreign Application Priority Data
Sep. 15, 2009 (JP) 2009-213412

(51) Int. Cl. G06F 9/445

(52) U.S. Cl. 717/177

(57) ABSTRACT

A software management apparatus includes a software-information obtaining unit that, when receiving a first installation request for installation of a software component onto an image forming apparatus specified by a user, obtains software information on the software component requested to be installed from a software distribution server; a request generating unit that generates a second installation request for installation of the software component requested to be installed based on the software information on the software component requested to be installed and the device information on the specified image forming apparatus; and a request transmitting unit that transmits the second installation request to the specified image forming apparatus so as to cause the software component, which is requested to be installed, to be installed onto the specified image forming apparatus.

### CROSS-REFERENCE TO RELATED APPLICATIONS

The present application claims priority to and incorporates by reference the entire contents of Japanese Patent Application No. 2009-213412 filed in Japan on Sep. 15, 2009.

### BACKGROUND OF THE INVENTION

1. Field of the Invention

The present invention is directed generally to a software management apparatus, a software distribution server, a software distribution system, a software installation method.

2. Description of the Related Art

In recent years, an image forming apparatus is typically configured such that a new additional application software (hereinafter, “application”) developed by a user or a third vendor, which is a third party, is installable onto the image forming apparatus. Various techniques for installing program codes, such as an application, onto a multifunction peripheral (MFP) have been proposed (see, for instance, Japanese Patent No. 3602036).

However, conventional techniques are disadvantageous in requiring a user who installs a new software component onto an image forming apparatus to have knowledge about what software components have already been installed onto the image forming apparatus when the user operates the image forming apparatus to perform installation, which makes installation operation to be performed by a user complicated.

The present invention has been made in view of the above circumstances and aims at providing a software management apparatus that facilitates installation operation to be performed by a user, a software distribution server, a software distribution system, a software installation method, and a computer program product.

### SUMMARY OF THE INVENTION

It is an object of the present invention to at least partially solve the problems in the conventional technology.

According to an aspect of the present invention, there is provided a software management apparatus connected to a software distribution server that distributes a software component and to one or more image forming apparatuses via a network, the software management apparatus comprising: a device-information receiving unit that receives from an external entity at predetermined timing, device information that contains installed-software information on a software component that has already been installed onto the image forming apparatus; a device-information storing unit that stores therein the device information received by the device-information receiving unit; a software-information obtaining unit that, when receiving a first installation request for installation of a software component onto an image forming apparatus specified by a user, obtains software information on the software component requested to be installed from the software distribution server; a request generating unit that generates a second installation request for installation of the software component requested to be installed based on the software information on the software component requested to be installed and the device information on the specified image forming apparatus; and a request transmitting unit that transmits the second installation request to the specified image forming apparatus so as to cause the software component requested to be installed onto the specified image forming apparatus.

According to another aspect of the present invention, there is provided a software distribution server that is connected to one or more image forming apparatuses and a software management apparatus that manages installation of a software component via a network, and that distributes a software component to one of the image forming apparatuses, the software distribution server comprising: a software storing unit that stores therein the software component and software information on the software component; a software-information-request receiving unit that receives an information request for software information on a software component requested to be installed from the software management apparatus; a software-information extraction unit that extracts the software information on the software component requested to be installed from the software storing unit upon receiving the information request; and a software-information transmitting unit that transmits the extracted software information on the software component requested to be installed to the software management apparatus.

According to still another aspect of the present invention, there is provided a software distribution system comprising: one or more image forming apparatuses; a software distribution server that distributes a software component to one or more of the image forming apparatuses; and a software management apparatus that is connected to the image forming apparatuses and to the software distribution server via a network, and that manages installation of the software component, wherein the image forming apparatus transmits, at predetermined timing to the software management apparatus, device information that contains installed-software information on a software component that has already been installed onto the image forming apparatus, the software management apparatus includes: a device-information receiving unit that receives the device information from the one or more image forming apparatuses; a device-information storing unit that stores therein the received device information; a software-information obtaining unit that, when receiving a first installation request for installation of a software component onto an image forming apparatus specified by a user, transmits to the software distribution server an information request for software information on the software component requested to be installed and receives the software information on the software component requested to be installed from the software distribution server; a request generating unit that generates a second installation request for installation of the software component requested to be installed based on the software information on the software component, which is requested to be installed, and the device information on the specified image forming apparatus; and a request transmitting unit that transmits the second installation request to the specified image forming apparatus so as to cause the software component, which is requested to be installed, to be installed onto the specified image forming apparatus, and the software distribution server includes: a software storing unit that stores therein the software component and software information on the software component; a software-information-request receiving unit that receives the information request; and a software-information transmitting unit that obtains from the software storing unit, the software information on the software component requested to be installed, which is specified in the information request, and transmits the obtained software information to the software management apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a network configuration diagram of a software distribution system according to a first embodiment of the present invention;

FIG. 2 is a block diagram illustrating a functional configuration of a management apparatus 500;

FIG. 3 is an explanatory diagram illustrating an example data structure of device information;

FIG. 4 is an explanatory diagram illustrating an example data structure of software information;

FIG. 5 is an explanatory diagram illustrating an example data structure of a second installation request;

FIG. 6 is a block diagram illustrating a functional configuration of a software distribution server 400;

FIG. 7 is a block diagram illustrating a functional configuration of an intermediary apparatus 200;

FIG. 8 is a sequence diagram illustrating flow of the device information;

FIG. 9 is a sequence diagram illustrating control flow for installation process according to the first embodiment;

FIG. 10 is a flowchart of a procedure for software-information extraction process and installation-request creation process according to the first embodiment;

FIG. 11 is an explanatory diagram illustrating an example of software information extraction;

FIG. 12 is a block diagram illustrating a functional configuration of a management apparatus 1200 according to the first embodiment;

FIG. 13 is a block diagram illustrating a functional configuration of a software distribution server 1300 according to a second embodiment of the present invention;

FIG. 14 is a sequence diagram illustrating control flow for installation process according to the second embodiment;

FIG. 15 is a flowchart of a procedure for software-information extraction process performed by the software distribution server according to the second embodiment;

FIG. 16 is a flowchart of a procedure for installation-request creation process performed by the management apparatus 1200;

FIG. 17 is a network configuration diagram of a software distribution system according to a third embodiment of the present invention;

FIG. 18 is a functional block diagram of an MFP 1700 according to the third embodiment;

FIG. 19 is a sequence diagram illustrating control flow for installation process according to the third embodiment; and

FIG. 20 is a functional block diagram of an MFP 1700 according to the third embodiment.

### DETAILED DESCRIPTION OF THE PREFERRED EMBODIMENTS

Exemplary embodiments of the present invention are described in detail below with reference to the accompanying drawings. The embodiments will be described by way of examples, in each of which an image forming apparatus according to an aspect of the invention is implemented into an multifunction peripheral (MFP) that has at least two functions of a copier function, a printer function, a scanner function, and a facsimile function; however, the image forming apparatus can be implemented into any image forming apparatus, such as a copier, a printer, a facsimile, or a scanner.

### First Embodiment

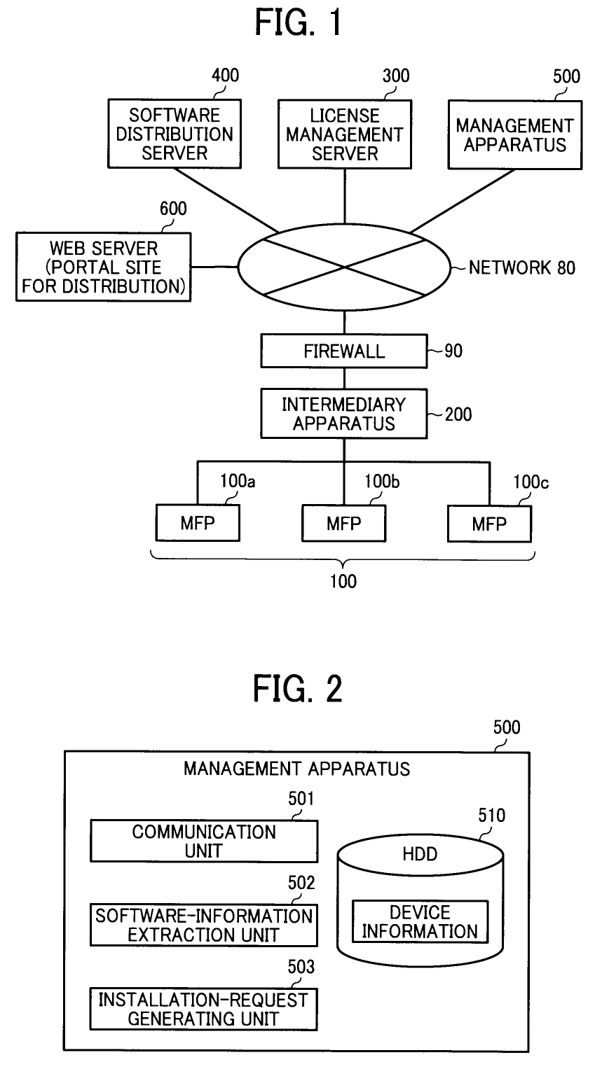

FIG. 1 is a network configuration diagram of a software distribution system according to a first embodiment of the present invention. As illustrated in FIG. 1, the software distribution system includes an intermediary apparatus 200, a license management server 300, a software distribution server 400, a management apparatus 500 serving as a software management apparatus, and a web server 600 that are connected to one another with a network 80, such as the Internet. A firewall 90 is provided between the intermediary apparatus 200 and the network 80. A plurality of MFPs, or more specifically MFPs 100a, 100b, and 100c (hereinafter, “MFP 100” is used to denote a not-specified one of the MFPs), are connected to the intermediary apparatus 200.

The firewall 90 monitors traffic passing across a boundary from outside, and detects and blocks unauthorized electronic access so as to prevent unauthorized operation performed by a third party that has intruded into the intermediary apparatus 200 via an external network, such as a public line or the Internet.

The software distribution server 400 that stores software components, which are various application software packages to be executed by the MFP 100, is a server apparatus that distributes one or more of the software components to the MFP 100 via the intermediary apparatus 200.

The license management server 300 is an apparatus that manages licenses (authorizations) of application software components, which are provided by the software distribution server 400 and are installed onto the MFP 100, and licenses (authorizations) of functions to be performed by the MFP 100 via the intermediary apparatus 200.

The web server 600 is a server apparatus that includes a portal site for distribution of software, such as an application. A user accesses the portal site for distribution in the web server 600 from a personal computer (PC) (not shown), the MFP 100, or the like to purchase a desired application software package. When the user has purchased software from the web server 600, a device identification (ID) of the MFP 100 specified as an installation target, onto which the purchased software is to be installed, and a product ID and a product key of the purchased software are transmitted together with a request for installation (hereinafter, “first installation request”) from the web server 600 to the management apparatus 500.

The management apparatus 500 remotely manages the MFP 100 via the intermediary apparatus 200. More specifically, the management apparatus 500 is a server apparatus placed in a service center of manufacturer, service provider, or the like of the MFP 100. Upon receiving the first installation request from the web server 600, the management apparatus 500 receives a uniform resource locator (URL) of a location (hereinafter, “software GET URL”), from which a to-be-installed software component is to be obtained, and URLs (hereinafter, “dependent-software GET URLs”) of locations, from which dependent software components are to be obtained, from the software distribution server 400. The management apparatus 500 refers to the device information that indicates states of software components already installed onto the MFP 100 specified as an installation target, thereby determining dependent software components that are necessary for the MFP 100. Furthermore, the management apparatus 500 transmits a second installation request for installation of the to-be-installed software component and the dependent software components.

The intermediary apparatus 200 is an apparatus that intermediates processing performed by and between the MFP 100, and the software distribution server 400 and the license management server 300. More specifically, the intermediary apparatus 200 collects device information that indicates states of software components already installed onto the MFP 100 on an MFP-by-MFP basis at regular time intervals and transmits this MFP-by-MFP device information to the management apparatus 500.

The intermediary apparatus 200 sends a request for a to-be-installed software component to the software distribution server 400 and receives the software therefrom. The intermediary apparatus 200 also sends a request for a license for the to-be-installed software component to the license management server 300 and receives the license therefrom. The intermediary apparatus 200 transmits, together with the thus-obtained software component and the license, a request for installation of the software to the MFP 100, thereby causing the MFP 100 to install the to-be-installed software.

The MFP 100 is an apparatus that has a plurality of functions to serve as a copier, a facsimile, a printer, and the like. The MFPs 100 are connected via a local network, such as a local area network (LAN), to the intermediary apparatus 200. FIG. 1 illustrates an example where the three MFPs, or specifically the MFPs 100a, 100b, and 100c, are connected to the network; however, the number of the MFPs is not limited to three, and the software distribution system can include one, two, four, or more online MFPs. The MFP 100 includes an application-installation control unit that, upon receiving the software component and the license together with the request for installation from the intermediary apparatus 200, performs installation of the software component specified in the request.

The management apparatus 500 is described in detail below. FIG. 2 is a block diagram illustrating a functional configuration of the management apparatus 500. As illustrated in FIG. 2, the management apparatus 500 essentially includes a communication unit 501, a software-information extraction unit 502, an installation-request generating unit 503, and a hard disk drive (HDD) 510.

The communication unit 501 receives, from the web server 600, the first installation request that contains a device ID of the MFP 100 (hereinafter, “installation-target MFP 100”) specified by the user as the installation target, and a product name, a product ID, and a product key of a to-be-installed software component specified by the user. The communication unit 501 also performs a function as a device-information receiving unit that receives device information about the MFP 100 from the intermediary apparatus 200 at regular time intervals and stores the device information in the HDD 510.

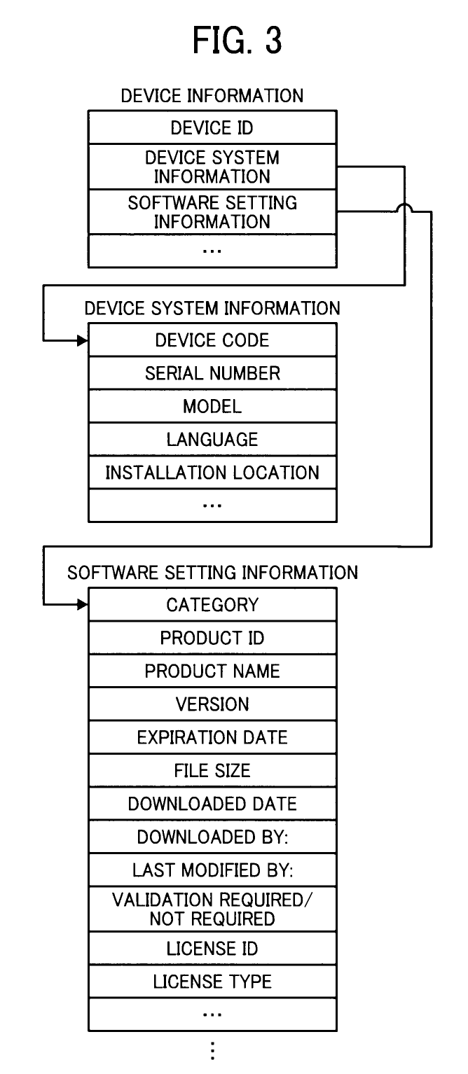

The device information contains the device ID that uniquely identifies the MFP 100, device system information that indicates a type of the MFP 100, and software setting information that is information about software component having already been installed onto the MFP 100 and that corresponds to installed-software information. FIG. 3 is an explanatory diagram illustrating an example data structure of the device information.

As illustrated in FIG. 3, the device information is configured such that the device system information is further linked with a table of detailed information as well as such that the software setting information is further linked with a table of detailed information about the software setting information. The software setting information is provided for each of software components installed onto the MFP 100 and linked to detailed information on software-by-software basis. Put another way, in a case where a plurality of software components have been installed onto the MFP 100, the device information is configured to contain a plurality of software setting information pieces, each of which is linked with a table of detailed information.

The detail information table of the device system information contains information on device code, serial number, model, language, installation location, and the like of the MFP 100 as presented in FIG. 3. The detail information table of the software setting information contains information on category, product ID that uniquely identifies the software component, product name, expiration date, license ID, and the like of the software component as presented in FIG. 3. Such device information as described above is stored in the HDD 510 for each the MFPs 100, or, put another way, on a device-ID-by-device-ID basis.

Referring back to FIG. 2, the communication unit 501 performs a function as a software-information obtaining unit that transmits a software-information GET request that contains the product ID that is contained in the first installation request fed from the web server 200 to specify the to-be-installed software component to the software distribution server 400 and receives the software information from the software distribution server 400.

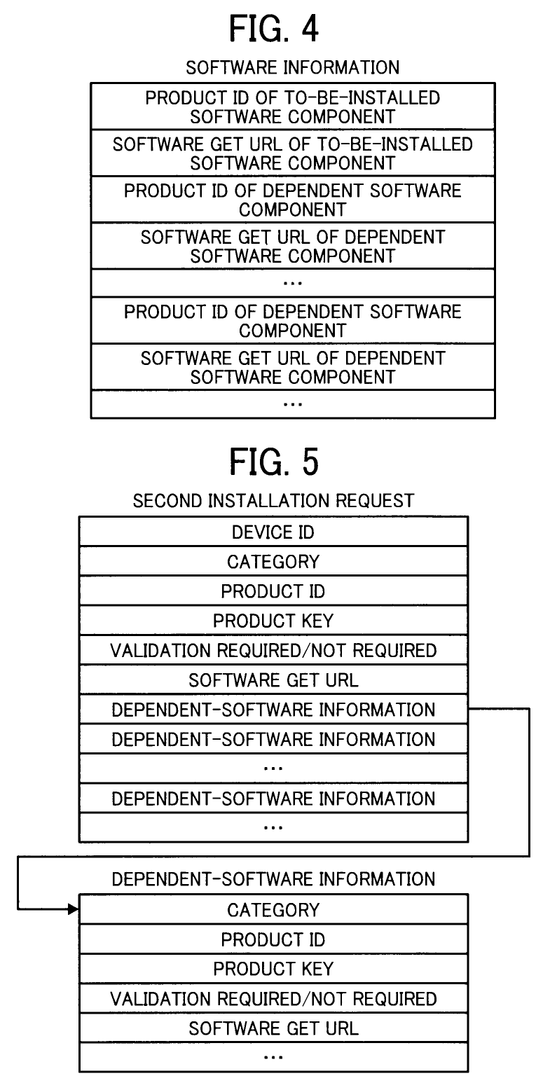

FIG. 4 is an explanatory diagram illustrating an example data structure of the software information. As illustrated in FIG. 4, the software information contains, in addition the product ID and the software GET URL of the to-be-installed software component, a product ID and a GET URL of a dependent software component, which is a software component that needs to be installed prior to installation of the to-be-installed software component. The product ID and the software GET URL of the dependent software component correspond to dependent-software information. In some cases, the to-be-installed software component involves a plurality of dependent software components. In addition to the information pieces given in FIG. 4, the software information contains information on category, product key, and information as to whether software validation is required for each of the to-be-installed software component and the dependent software components.

Referring back to FIG. 2, the communication unit 501 further performs a function as a request transmitting unit that generates a second installation request based on the device information and the software information and transmits the second installation request to the intermediary apparatus 200.

The software-information extraction unit 502 compares the product ID, which is included in software setting information of the installation-target MFP 100, with the product ID of each of the to-be-installed software component and dependent software components, on which the to-be-installed software component depends, in the received software information. Then, the software-information extraction unit 502 extracts a product ID, software GET URL, a product key, information as to whether software validation is required, and the like pertaining to each one of the dependent software components that is not installed onto the installation-target MFP 100 yet. The software setting information corresponds to the installed-software information in the device information, which is stored in the HDD 510, about the installation-target MFP 100. This prevents overlap installation of a dependent software component that has already been installed.

The installation-request generating unit 503 generates a second installation request for causing the MFP 100 to install the to-be-installed software component and the dependent software components based on the product ID and the software GET URL of each of the to-be-installed software component and the dependent software component extracted by the software-information extraction unit 502.

FIG. 5 is an explanatory diagram illustrating an example data structure of the second installation request. As illustrated in FIG. 5, the second installation request is configured to contain, in addition to the device ID of the installation target, the category, the product ID, the product key, the software GET URL, and the like of the to-be-installed software target and the product IDs, the product keys, the software GET URLs, and the like of the dependent software components extracted by the software-information extraction unit 502 from the dependent-software information.

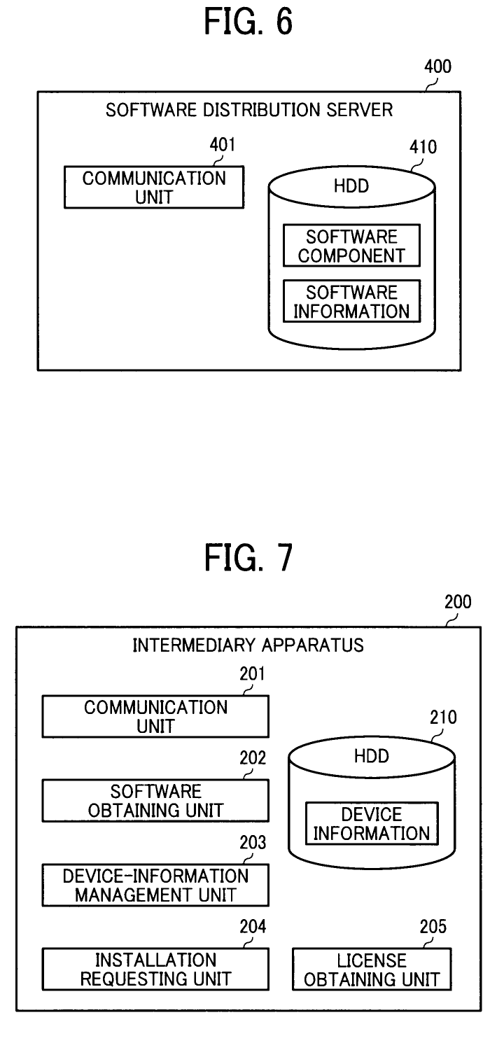

The software distribution server 400 is described in detail below. FIG. 6 is a block diagram illustrating a functional configuration of the software distribution server 400. As illustrated in FIG. 6, the software distribution server 400 includes a communication unit 401 and an HDD 410.

A software component, which is a software installation package, and the software information illustrated in FIG. 4 that corresponds to the software component are stored in the HDD 410.

Upon receiving a software-information GET request for the software information from the management apparatus 500, the communication unit 401 retrieves the software information corresponding to the product ID specified in the software-information GET request from the HDD and transmits the retrieved software information to the management apparatus 500. Upon receiving the software request from the intermediary apparatus 200, the communication unit 501 retrieves the specified software component from the HDD 510 and distributes the retrieved software component to the intermediary apparatus 200.

The intermediary apparatus 200 is described in detail below. FIG. 7 is a block diagram illustrating a functional configuration of the intermediary apparatus 200. As illustrated in FIG. 7, the intermediary apparatus 200 essentially includes a communication unit 201, a software obtaining unit 202, a license obtaining unit 205, a device-information management unit 203, and an installation requesting unit 204.

The communication unit 201 receives device information from the MFP 100 at regular time intervals, which corresponds to predetermined timing, stores the device information in an HDD 210, and also transmits the device information to the management apparatus 500. The device-information management unit 203 manages the device information stored in the HDD 210.

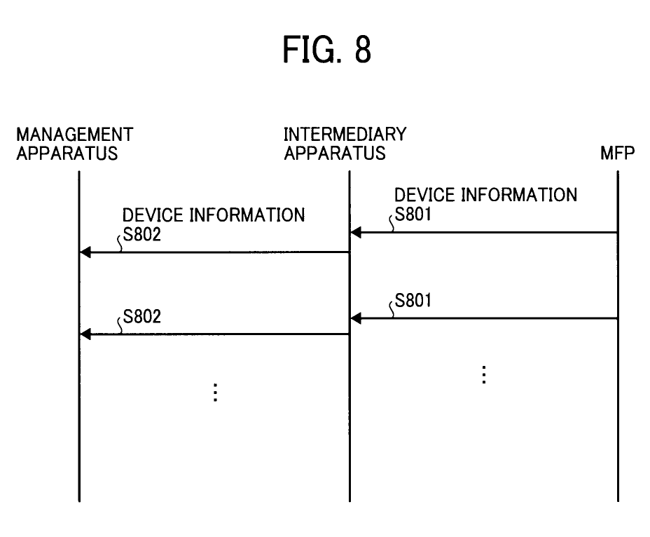

FIG. 8 is a sequence diagram illustrating flow of device information. As illustrated in FIG. 8, the intermediary apparatus 200 receives device information from the MFP 100 at regular time intervals (Step S801), and transmits the device information to the management apparatus 500 at regular time intervals (Step S802).

Referring back to FIG. 7, upon receiving the second installation request from the management apparatus 500, the software obtaining unit 202 transmits a request for the to-be-installed software component and the dependent software components specified in the second installation request to the software distribution server 400. Then, the management apparatus 500 receives the to-be-installed software component and the dependent software components from the software distribution server 400.

Upon receiving the second installation request from the management apparatus 500, the license obtaining unit 205 transmits a request for licenses of the to-be-installed software component and the dependent software components specified in the second installation request to the license management server 300 and receives the licenses from the license management server 300.

The installation requesting unit 204 transmits, together with the obtained software components and the licenses, a request for installation to the installation-target MFP 100. Upon receiving the request for installation, the MFP 100 starts installation.

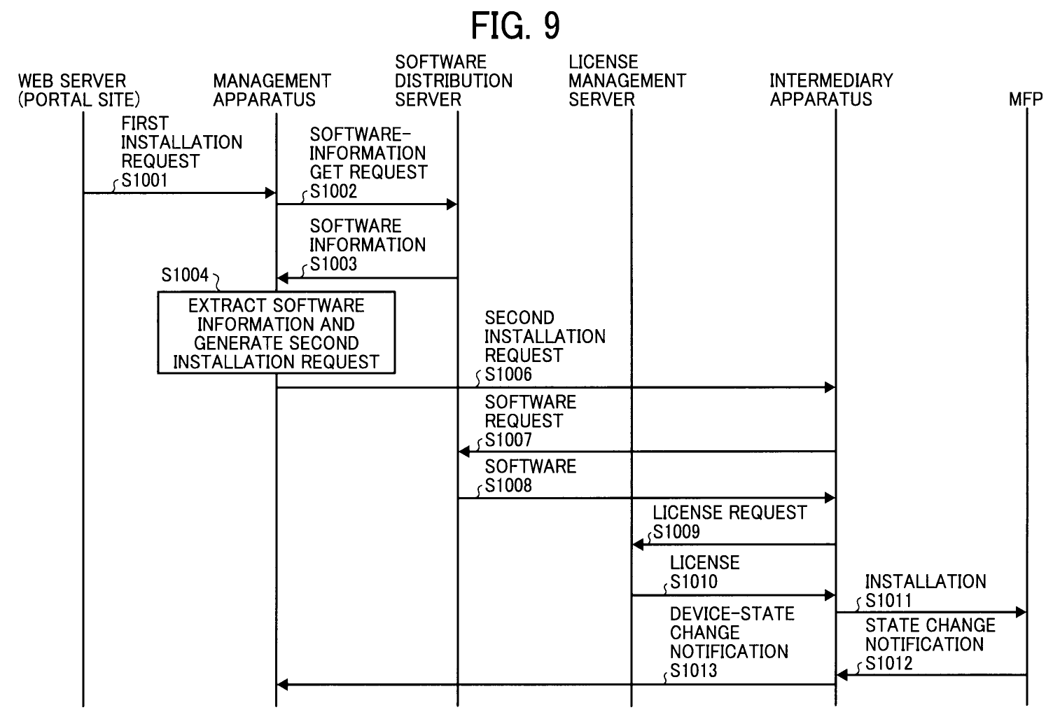

Installation process performed in the software distribution system configured as described above according to the first embodiment is described below. FIG. 9 is a sequence diagram illustrating control flow for the installation process according to the first embodiment.

When the management apparatus 500 has received the first installation request from the web server 600 (Step S1001), the management apparatus 500 transmits a software-information GET request to the software distribution server 400 (Step S1002). In response thereto, the software distribution server 400 transmits software information on the software component specified in the request to the management apparatus 500 (Step S1003). The management apparatus 500 extracts dependent-software information necessary for the installation-target MFP 100 based on the device information and the software information, and generates a second installation request using the extracted dependent-software information and the software information about the to-be-installed software component (Step S1004). The management apparatus 500 transmits the second installation request to the intermediary apparatus 200 (Step S1006).

Upon receiving the second installation request, the intermediary apparatus 200 transmits a software request to the software distribution server 400 to obtain the to-be-installed software component and the dependent software components specified in the second installation request (Step S1007), and receives these necessary software components from the software distribution server 400 (Step S1008). The intermediary apparatus 200 transmits a license request to the license management server 300 to obtain licenses of the to-be-installed software component and the dependent software components specified in the second installation request (Step S1009), and receives the licenses from the license management server 300 (Step S1010). The intermediary apparatus 200 transmits, together with the received software components and the licenses, a request for installation to the MFP 100 specified as an installation target (Step S1011). Upon receiving the request for installation, the MFP 100 starts installation of the to-be-installed software component and the dependent software components necessary for installation of the to-be-installed software component. When the software components have been installed onto the MFP 100 and hence the number of software components installed onto the MFP 100 is increased, the MFP 100 transmits a device-state change notification that contains information about the additionally installed software components to the intermediary apparatus 200 (Step S1012). Upon receiving the device-state change notification, the intermediary apparatus 200 transfers this device-state change notification to the management apparatus 500 (Step S1013). Upon receiving the device-state change notification, the management apparatus 500 adds information about the additionally installed software components in the device-state change notification to the device information.

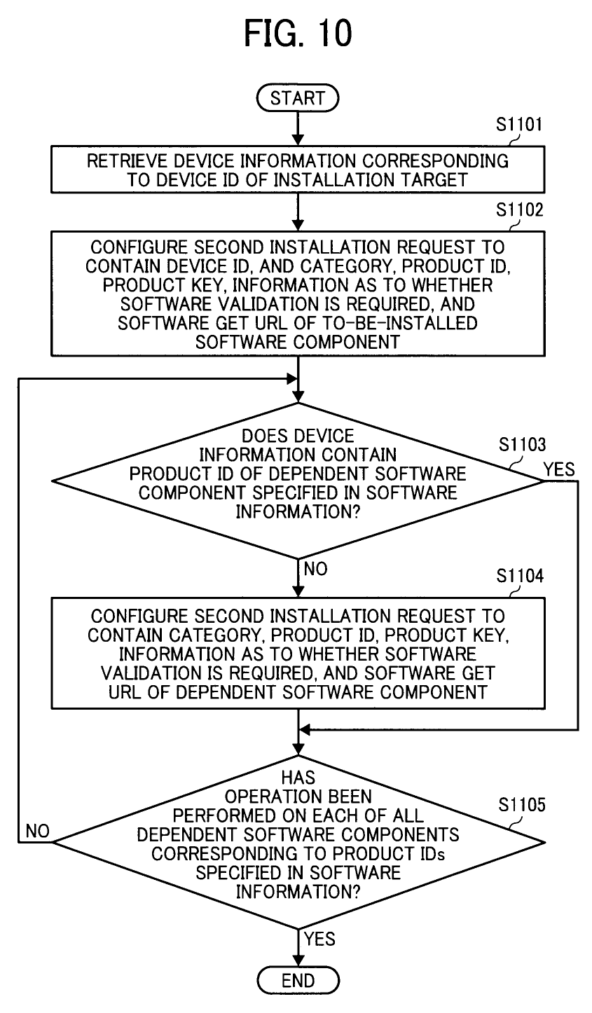

Software-information extraction process and installation-request creation process to be performed by the management apparatus 500 at Step S1003 are described in detail below. FIG. 10 is a flowchart of a procedure for the software-information extraction process and the installation-request creation process according to the first embodiment.

The installation-request generating unit 503 retrieves device information corresponding to the device ID of the installation-target MFP 100 from the HDD 510 (Step S1101). The installation-request generating unit 503 generates an empty second installation request and sets the device ID of the installation-target MFP 100 in the second installation request. In addition, the installation-request generating unit 503 sets in the second installation request, the category, the product ID, the product key, information as to whether software validation is required, the software GET URL, and the like, which are specified in the software information fed from the software distribution server 400, of the to-be-installed software component (Step S1102).

The software-information extraction unit 502 determines whether the retrieved device information contains the product ID of the dependent software component specified in the received software information (Step S1103). If the device information does not contain the product ID (No at Step S1103), a dependent software component corresponding to the product ID is not installed onto the MFP 100 yet. Accordingly, the installation-request generating unit 503 sets in the second installation request, the category, the product ID, the product key, the information as to whether software validation is required, the software GET URL, and the like of the not-installed dependent software component so that the not-installed dependent software component is installed (Step S1104).

In contrast, if the device information contains the product ID of the dependent software component specified in the software information (Yes at Step S1103), the dependent software component corresponding to the product ID has already been installed onto the MFP 100. Accordingly, because installation of the dependent software component is unnecessary, the operation to be performed at Step S1104 is skipped, and the second installation request is set not to contain the information on the dependent software component.

The software-information extraction unit 502 determines whether the operation to be performed at Step S1103 or S1104 has been performed on each of all the dependent software components specified in the software information (Step S1105). If the operation has not been completed yet (No at Step S1105), the operation to be performed at Step S1103 or S1104 is repeated. If the operation has been completed (Yes at Step S1105), the process ends.

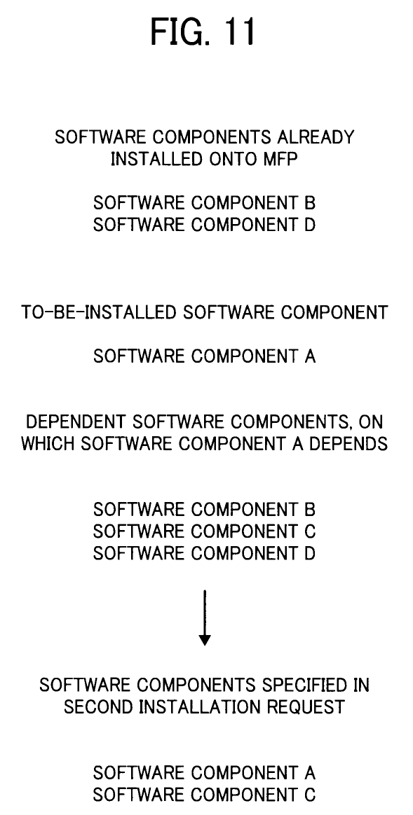

An example situation where device information about the MFP 100 indicates that a software component B and a software component D have already been installed onto the MFP 100 as illustrated in FIG. 11 is described. In the situation, it is also assumed that a software component A has been specified as a to-be-installed software component, and dependent software components, on which the software component A depends, are the software component B, a software component C, and the software component D.

According to the first embodiment, because the software component B and the software component D have already been installed onto the MFP 100, it is not necessary to install the software component B and the software component D. Accordingly, in this situation, a second installation request is set to contain software GET URL and the like information only on the software component A, which is the to-be-installed software component, and on the software component C, which is the dependent software component, and transmitted to the intermediary apparatus 200.

This eliminates the need for a user of the MFP 100 for determining whether there is a dependent software component, on which a to-be-installed software component depends, that has already been installed onto the MFP 100. Furthermore, this eliminates the need for downloading the to-be-installed software component and the dependent software component from locations indicated by software GET URLs. Hence, the first embodiment facilitates the installation operation to be performed by a user on the MFP 100. In the first embodiment, because the second installation request is generated based on the device information received via the intermediary apparatus 200 from the MFP 100, installation of a software component can be performed depending on usage status of the MFP 100 in a manner that facilitates the installation operation performed by a user.

### Second Embodiment

In the software distribution system according to the first embodiment, the management apparatus 500 makes determination as to what dependent software component has already been installed onto the installation-target MFP 100, and generates a second installation request that does not contain information on already-installed dependent software component based on a result of the determination. In contrast, in a second embodiment of the present invention, a software distribution server makes determination as to what dependent software component has already been installed onto the installation-target MFP 100, and sends a notification on a determination result to a management apparatus, which in turn generates a second installation request based on the result.

A software distribution system according to the second embodiment has a similar network configuration with that of the first embodiment. However, the configurations of the management apparatus and the software distribution server according to the second embodiment differ from those of the first embodiment.

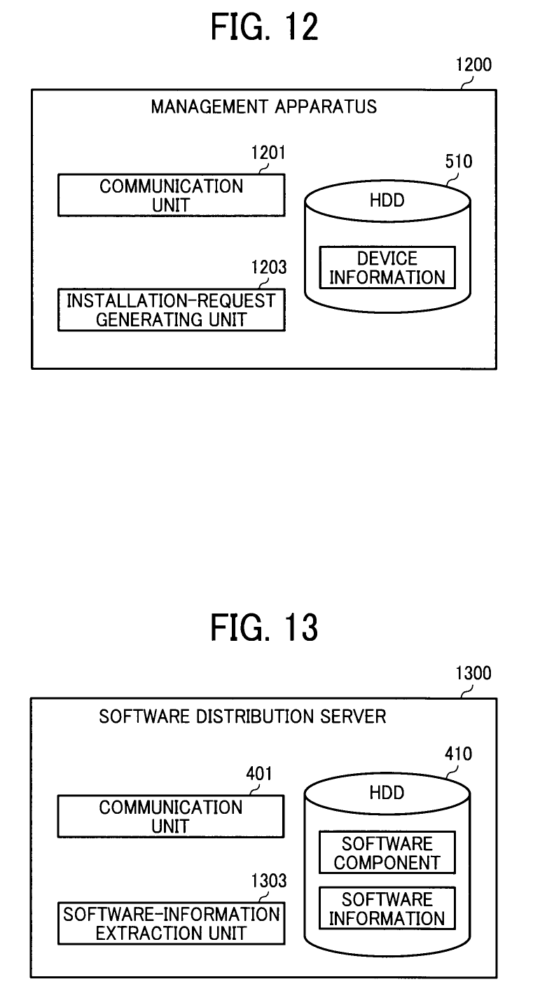

FIG. 12 is a block diagram illustrating a functional configuration of a management apparatus 1200 according to the first embodiment. The management apparatus 1200 according to the second embodiment essentially includes a communication unit 1201, an installation-request generating unit 1203, and the HDD 510 that stores device information as in the first embodiment.

The communication unit 1201 receives a first installation request from the web server 600 and transmits a second installation request to the intermediary apparatus 200 as in the first embodiment. The communication unit 1201 obtains software setting information based on a product ID of a to-be-installed software component and device information specified by a device ID in the first installation request. More specifically, the communication unit 1201 obtains, from the device information, a product ID of a software component having already been installed onto the MFP 100 specified by the device ID, generates a software-information GET request that contains the product ID, and transmits the software-information GET request to the software distribution server 1300. The communication unit 1201 receives software information that contains information on dependent software components, on which the to-be-installed software component depends, except for the already-installed software component (which is a dependent software component) from the software distribution server 1300.

The installation-request generating unit 1203 generates a second installation request that contains information, such as product IDs and software GET URLs of the installation software component and the dependent software components specified in the received software information.

FIG. 13 is a block diagram illustrating a functional configuration of the software distribution server 1300 according to the second embodiment. As illustrated in FIG. 13, the software distribution server 1300 according to the second embodiment essentially includes the communication unit 401, a software-information extraction unit 1303, and the HDD 410. Functions and the configurations of the communication unit 401 and the HDD 410 are similar to those of the first embodiment.

The software-information extraction unit 1303 according to the second embodiment retrieves software information corresponding to the product ID of the to-be-installed software component specified in the software-information GET request from the HDD 410. Then, the software-information extraction unit 1303 checks software components installed onto the installation-target MFP 100 specified in the software-information GET request against the retrieved software information in order to extract software information that contains a product ID, software GET URL, and the like of a software component (which is a dependent software component) that is not installed onto the MFP 100 yet.

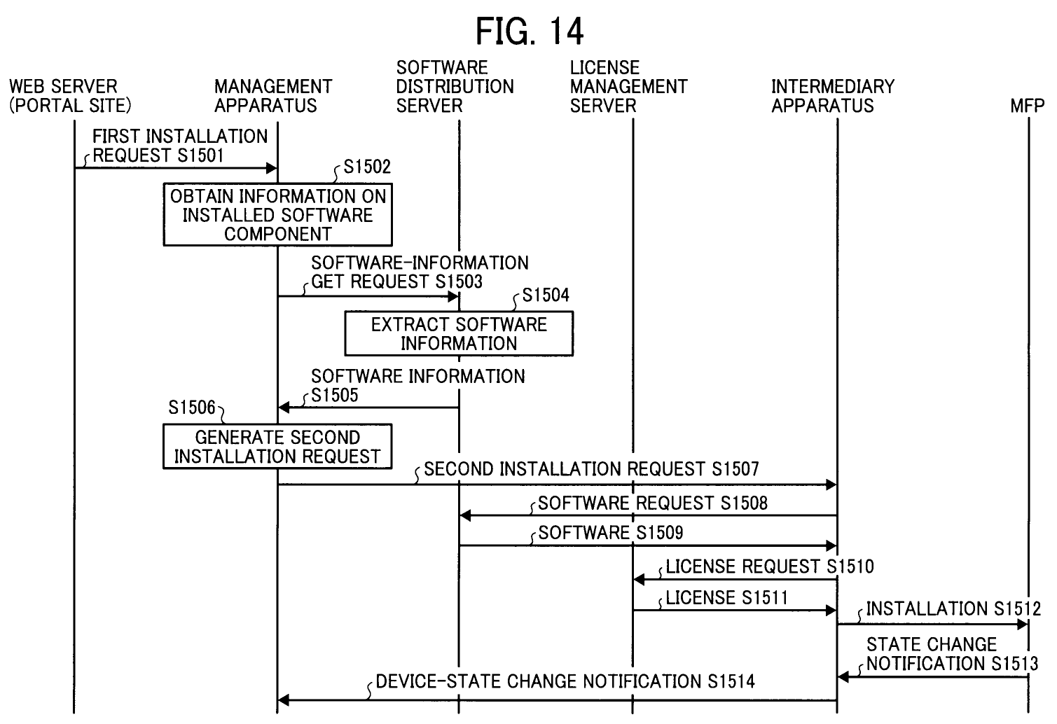

Installation process performed in the software distribution system configured as described above according to the second embodiment is described below. FIG. 14 is a sequence diagram illustrating control flow for the installation process according to the second embodiment.

Upon receiving a first installation request from the web server 600 (Step S1501), the management apparatus 1200 reads device information corresponding to a device ID of the installation-target MFP 100 specified in the first installation request from the HDD 510, and obtains information on already-installed software components, i.e., software setting information, from the device information (Step S1502). The management apparatus 1200 generates a software-information GET request that contains the software setting information (information about the already-installed software component) to the software distribution server 1300 (Step S1503).

Upon receiving the software-information GET request, the software distribution server 400 extracts software information about a software component that is not installed onto the installation-target MFP 100 yet (Step S1504), and transmits the extracted software information to the management apparatus 1200 (Step S1505).

The management apparatus 500 receives the software information, generates a second installation request based on the software information (Step S1506), and transmits the second installation request to the intermediary apparatus 200 (Step S1507). Subsequent operations to be performed from Step S1508 to S1514 are performed in a manner similar to those in the first embodiment.

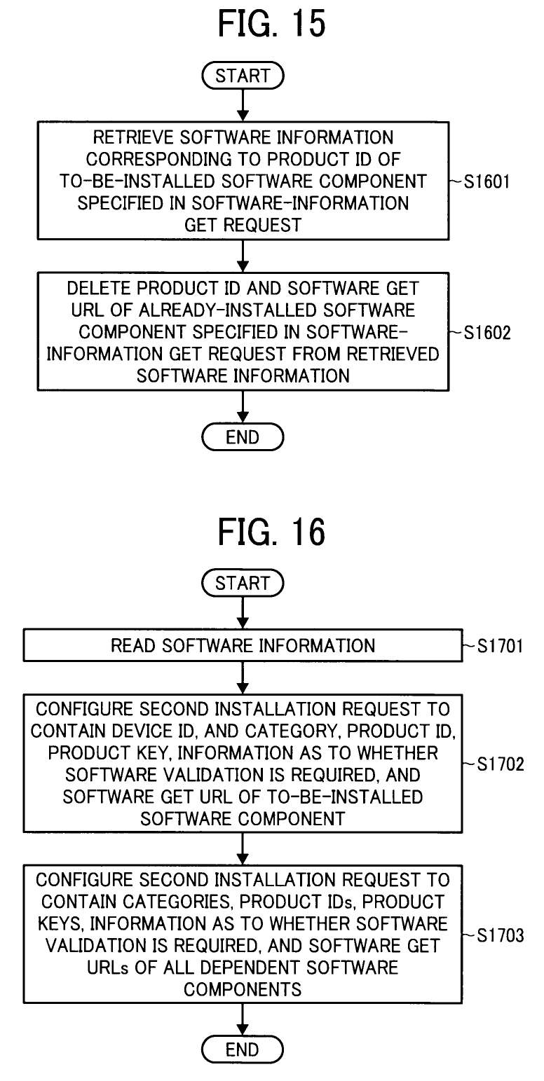

Software-information extraction process to be performed by the software distribution server at Step S1504 is described below. FIG. 15 is a flowchart of a procedure for the software-information extraction process performed by the software distribution server according to the second embodiment.

The software-information extraction unit 1303 of the software distribution server 1300 retrieves software information corresponding to the product ID of the to-be-installed software component specified in the software-information GET request fed from the management apparatus 1200 from the HDD 410 (Step S1601).

The software-information extraction unit 1303 deletes information on the already-installed software information, or, more specifically, the product ID and the software GET URL and the like pertaining to the already-installed software component specified in the software-information GET request, from the retrieved software information. Thus, the software-information extraction unit 1303 extracts software information on software component that is necessary for the installation-target MFP 100 (Step S1602). This software information is then transmitted to the management apparatus 1200.

Installation-request creation process to be performed by the management apparatus 1200 at Step S1506 is described below. FIG. 16 is a flowchart of a procedure for the installation-request creation process performed by the management apparatus 1200.

The installation-request generating unit 1203 of the management apparatus 1200 reads the software information fed from the software distribution server 1300 (Step S1701). The installation-request generating unit 1203 generates an empty second installation request and sets the device ID of the installation-target MFP 100 in the second installation request. In addition, the installation-request generating unit 1203 sets in the second installation request, the product ID, the product key, and the software GET URL of the to-be-installed software component specified in the software information (Step S1702).

The installation-request generating unit 1203 then sets in the second installation request, the product IDs, the product keys, and the software GET URLs of the dependent software components (more specifically, the dependent software components necessary for the MFP 100) specified in the software information (Step S1703). The second installation request that has thus been generated is transmitted to the intermediary apparatus 200.

As described above, in the second embodiment, an effect similar to that obtained by the first embodiment is obtained. Furthermore, according to the second embodiment, the software distribution server 1300 makes determination as to what dependent software component has already been installed onto the installation-target MFP 100, and transmits software information based on a result of the determination to the management apparatus 1200, which in turn generates a second installation request based on the software information. Accordingly, because operations from extraction of software information necessary for the MFP 100 to creation of the second installation request can be distributed, efficiency in the operations can be enhanced.

In the first and second embodiments, the configuration, in which upon receiving a second installation request, the intermediary apparatus 200 obtains a to-be-installed software component and licenses from the software distribution server 400 and the license management server 300, respectively, and transmits the to-be-installed software component and the licenses to the MFP 100, is employed; however, the configuration is not limited thereto. For instance, another configuration, in which the management apparatus 500 obtains a to-be-installed software component and licenses from the software distribution server 400 and the license management server 300, respectively, and transmits the to-be-installed software component and the licenses to the intermediary apparatus 200, which in turn transmits the to-be-installed software component and the licenses together with a request for installation to the MFP 100, can alternatively be employed.

### Third Embodiment

In the first and second embodiments, receipt of device information from the MFP 100 and transmission of installation request to the MFP 100 have been performed via the intermediary apparatus 200. In contrast, in a third embodiment according to the present invention, data is transmitted and received to and from the MFP 100 directly rather than via the intermediary apparatus 200.

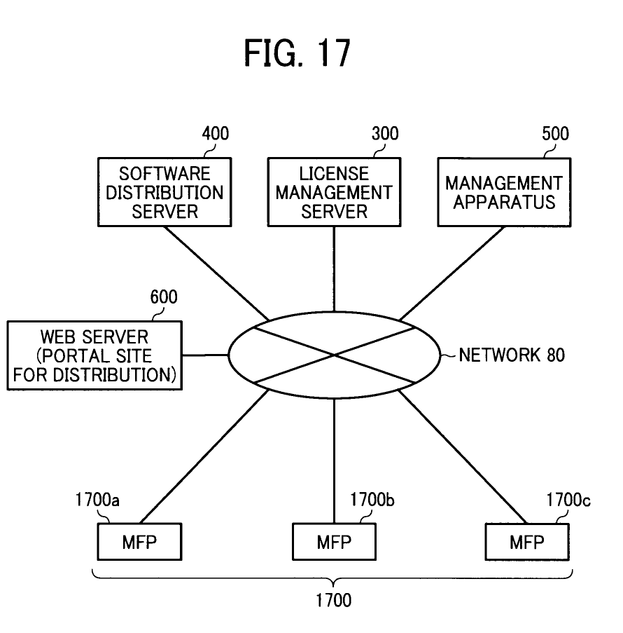

FIG. 17 is a network configuration diagram of a software distribution system according to the third embodiment. As illustrated in FIG. 17, the software distribution system according to the third embodiment includes the management apparatus 500, the software distribution server 400, the license management server 300, the web server 600, and MFPs 1700 (1700a, 1700b, and 1700c) that are connected to one another with the network 80 but does not include the intermediary apparatus 200.

The configurations of the management apparatus 500, the software distribution server 400, the license management server 300, and the web server 600 are similar to those of the first embodiment. Note that the management apparatus 500 receives device information directly from the MFP 1700 and transmits a second installation request directly to the MFP 1700.

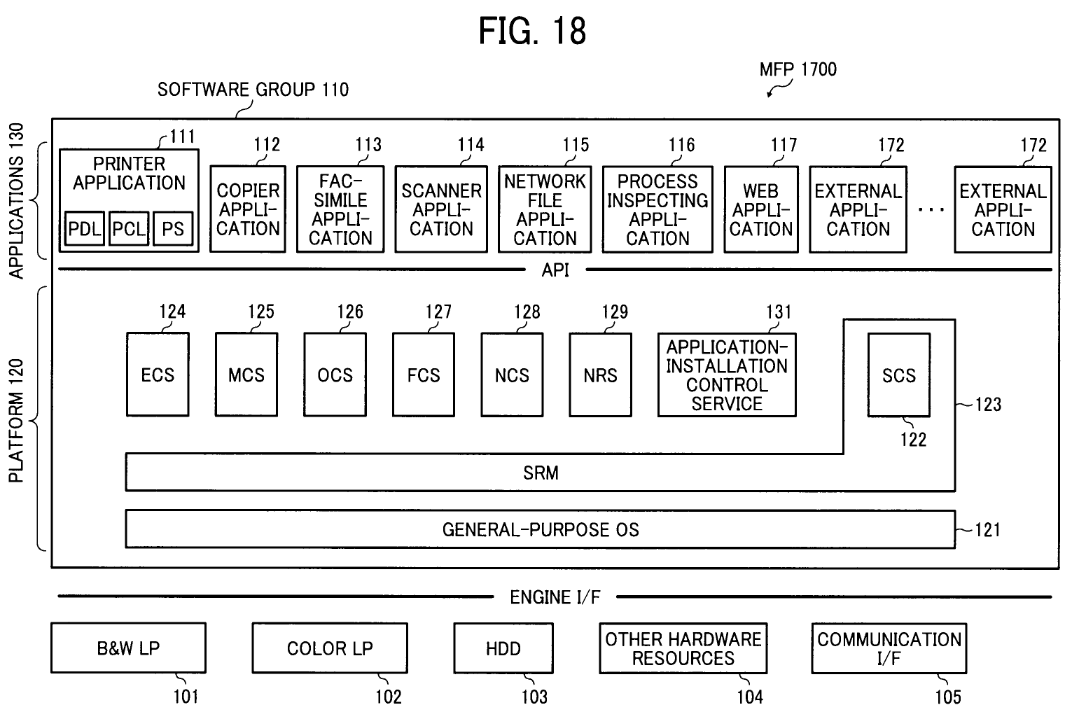

The MFP 1700 is described below. FIG. 18 is a functional block diagram of the MFP 1700 according to the third embodiment. As illustrated in FIG. 18, the MFP 1700 includes a black-and-white laser printer (B&W LP) 101, a color laser printer (color LP) 102, an HDD 103, hardware resources 104 that include a scanner, a facsimile, and memory, a communication interface (I/F) 105, and a software group 110 that includes a platform 120 and applications 130.

In the MDP 1700 according to the third embodiment, device information, an application software package downloaded from the software distribution server 400, a firmware package, package information, instructions serving as operation instructions for installation process, and license file of application downloaded from the license management server 300 are stored in the HDD 103. The progress of the installation process is also recorded in the HDD 103.

The platform 120 includes control services, each of which interprets a process request fed from an application and issues a resource request for a hardware resource, a system resource manager (SRM) 123 that manages one or more hardware resources and arbitrates resource requests from the control service, and a versatile operating system (OS) 121.

The control service includes a plurality of service modules, or specifically a system control service (SCS) 122, an engine control service (ECS) 124, a memory control service (MCS) 125, an operation panel control service (OCS) 126, a facsimile control service (FCS) 127, a network control service (NCS) 128, a new remote service (NRS) 129, and an application-installation control service 131. The platform 120 includes an application program interface (API) that allows receipt of processing request from the applications 130 by using functions defined in advance.

The versatile OS 121, which is a versatile operating system such as UNIX (registered trademark), executes software programs of the platform 120 and the applications 130 concurrently as parallel processes.

The SRM 123 performs a process for system control and resource management in cooperation with the SCS 122. More specifically, the SRM 123 performs a process for arbitration, execution, and control according to a request fed from an upper layer that uses hardware resource, such as an engine of a scanner unit, a printer unit, or the like, memory, an HDD file, or a host input/output (I/O) (e.g., a Centronics-compatible I/F, a network I/F, an IEEE 1394 (the Institute of Electrical and Electronics Engineers 1394) I/F, or an RS-232C I/F).

More specifically, the SRM 123 determines whether the requested hardware resource is available (i.e., whether the requested hardware resource is currently used for another request), and if the requested hardware resource is available, sends a notification that the requested hardware resource is available to the upper layer. The SRM 123 also arranges, in response to a request from the upper layer, a schedule for utilization of hardware resource and directly performs a requested operation (e.g., memory allocation, file creation, or causing a printer engine to perform paper feeding and image forming).

The SCS 122 performs a process for application management, control of an operating unit, displaying system-related screens, indication with light-emitting diodes (LEDs), resource management, control of application interruption, and the like.

The ECS 124 performs a process for engine control of the hardware resources 104 that include the B&W LP 101, the color LP 102, the scanner, and the facsimile.

The MCS 125 performs a process for allocation and release of image memory, utilization of the HDD, compression and decompression of image data, and the like.

The FCS 127 performs a process for provision of an API that allows facsimile transmission to and reception from each application layer of a system controller by using a public switched telephone network (PSTN) or an integrated services digital network (ISDN) network, storing and retrieving facsimile data in and from a backup SRAM (BKM) that manages various facsimile data pieces, scanning for facsimile transmission, printing of received facsimile data, and transmission and reception by using combined functions.

The NCS 128 performs a process for provision of services that are common among applications that require network I/O. More specifically, the NCS 128 intermediates allocation of data pieces, which are received via the network by using various protocols, to the applications and data transmission from the applications to the network.

The OCS 126 performs a process for control of an operation panel (control panel) that serves as an interface between an operator (user) and control of the apparatus. When a key is pressed (or touched) on the operation panel, the OCS 126 recognizes it as a key event. The OCS 126 includes a portion serving as an OCS process that transmits a key event function corresponding to the thus-recognized key to the SCS 122 and a portion serving as an OCS library. In the OCS library, rendering functions that cause various images to be rendered and displayed on the operation panel according to a request from any one of the applications 130 and the control services, other control functions for the operation panel, and the like are stored in advance. The OCS library is implemented as being linked with various modules of the applications 130 and the control services. The entire OCS 126 can be configured so as to operate as the OCS process. Alternatively, the entire OCS 126 can be configured as the OCS library.

The application-installation control service 131 performs a process for transmission of device information that contains information about software, such as application installed onto the MFP 1700, and information on device, to the management apparatus 500 at regular time intervals. Upon receiving a second installation request from the management apparatus 500, the application-installation control service 131 performs a process of issuing a distribution request for a to-be-installed software component specified by a product ID in the second installation request to the software distribution server 400, receiving the to-be-installed software component from the software distribution server 400, and installing the to-be-installed software component. The application-installation control service 131 also performs a process, upon receiving the second installation request from the management apparatus 500, of issuing a request for a license specified by the product ID in the second installation request to the license management server 300, thereby obtaining the license from the license management server 300.

The NRS 129 performs a process for a function related to device remote management via the network, such as data conversion for transmission and reception of data via the network, and a scheduler function.

The applications 130 include a printer application 111 that is an application for a printer that has a page description language (PDL) and a post script (PS), a copier application 112 that is an application for a copier, a facsimile application 113 that is an application for a facsimile, a scanner application 114 that is an application for a scanner, a network file application 115 that is an application for a network file, a process inspecting application 116 that is an application for process inspection, and a web application 117 that serves as a web server (hypertext transfer protocol (http) server) and displays various screens on a web browser that is executed on a client terminal.

Each of processes performed by the applications 130 and the processes performed by the control services provides a user service related to image forming operation such as a copier, a printer, a scanner, a facsimile, or the like by performing function call and return value transmission in response to the function call and exchanging messages for inter-process communications.

As described above, the MFP 1700 according to the third embodiment includes the plurality of applications 130 and the plurality of control services, each of which is run as a process. One or multiple threads are generated in each of the processes, in which the threads are run concurrently. The control services provide common services to the applications 130. Accordingly, a large number of processes are performed concurrently and threads are run concurrently while the processes and the threads carry out inter-process communications for cooperation with one another, thereby providing a user service related to image forming operation such as the copier, the printer, the scanner, the facsimile, or the like.

The MFP 1700 is configured such that a third party, such as a customer or a third vendor, of the MFP 1700 can develop an external application 172 and install the external application 172 on an application layer, which is an upper layer of a control service layer. The external application 172 is an application downloaded from the software distribution server 400 and installed by the application-installation control service 131. FIG. 18 illustrates a state where the applications are run.

The plurality of processes of the application programs 130 and the plurality of processes of the control services are run in the MFP 1700 according to the third embodiment; however, alternatively, the MFP 1700 can configured such that a single process of the application programs 130 and a single process of the control services are run on the MFP 1700. Application can be added to or deleted from the applications 130 on an application-by-application basis. Put another way, the external application 172 can be installed to or uninstalled from the MFP 1700 as described above.

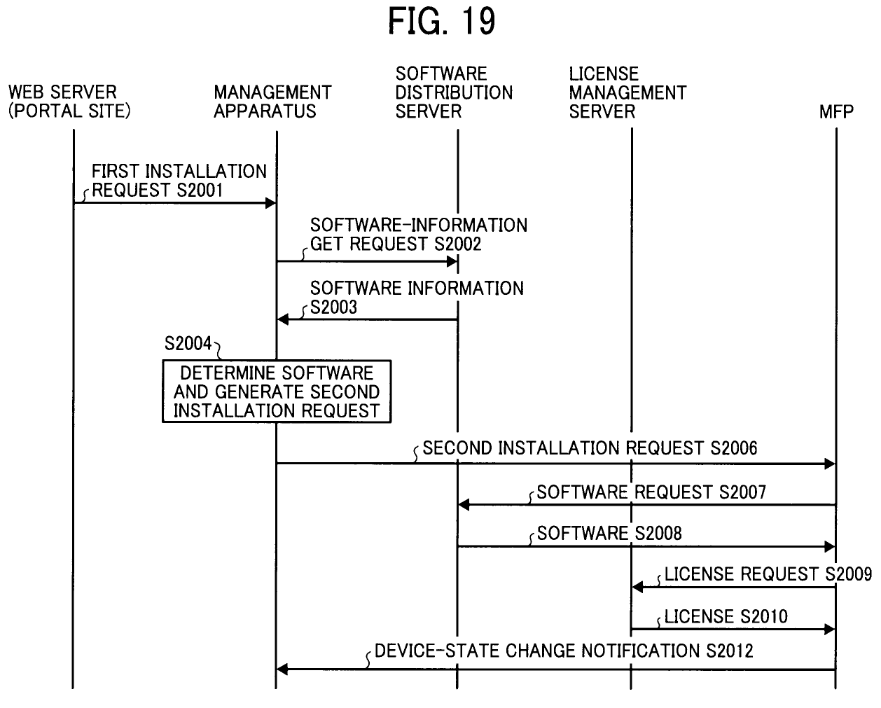

Installation process performed in the software distribution system according to the third embodiment configured as described above is described below. FIG. 19 is a sequence diagram illustrating control flow for the installation process according to the third embodiment.

Operations to be performed from Step S2001, at which a first installation request is received, to S2004, at which a second installation request is generated, are performed in a manner similar to those in the first embodiment. When the second installation request has been generated, the management apparatus 500 transmits the second installation request to an address of the MFP 1700 specified by the web server 600 (Step S2006).

Upon receiving the second installation request from the management apparatus 500, the MFP 1700 issues a distribution request for a software component specified by product ID in the second installation request to the software distribution server 400 (Step S2007), and receives the software component from the software distribution server 400 (Step S2008).

The MFP 1700 transmits a license request for license of the software component specified by the product ID in the second installation request to the license management server 300 by using the application-installation control service 131 (Step S2009), and receives the license from the license management server 300 (Step S2010). Thereafter, the MFP 1700 performs installation of the software component specified in the second installation request. Because the number of software components installed onto the MFP 1700 has thus been increased, the MFP 1700 directly transmits a device-state change notification to the management apparatus 500 (Step S2012).

As described above, in the third embodiment, an effect similar to that obtained by the first embodiment is obtained. Furthermore, according to the third embodiment, because the management apparatus 500 and the MFP 1700 exchange various data pieces and requests directly with each other, a period of time required for installation can be shortened.

In the third embodiment, the configuration, in which upon receiving a second installation request, the MFP 1700 obtains a to-be-installed software component and a license therefor from the software distribution server 400 and the license management server 300, respectively, is employed; however, the configuration is not limited thereto. For instance, another configuration, in which the management apparatus 500 obtains a to-be-installed software component and a license therefor from the software distribution server 400 and the license management server 300, respectively, and transmits the to-be-installed software component and the license to the MFP 100, can alternatively be employed.

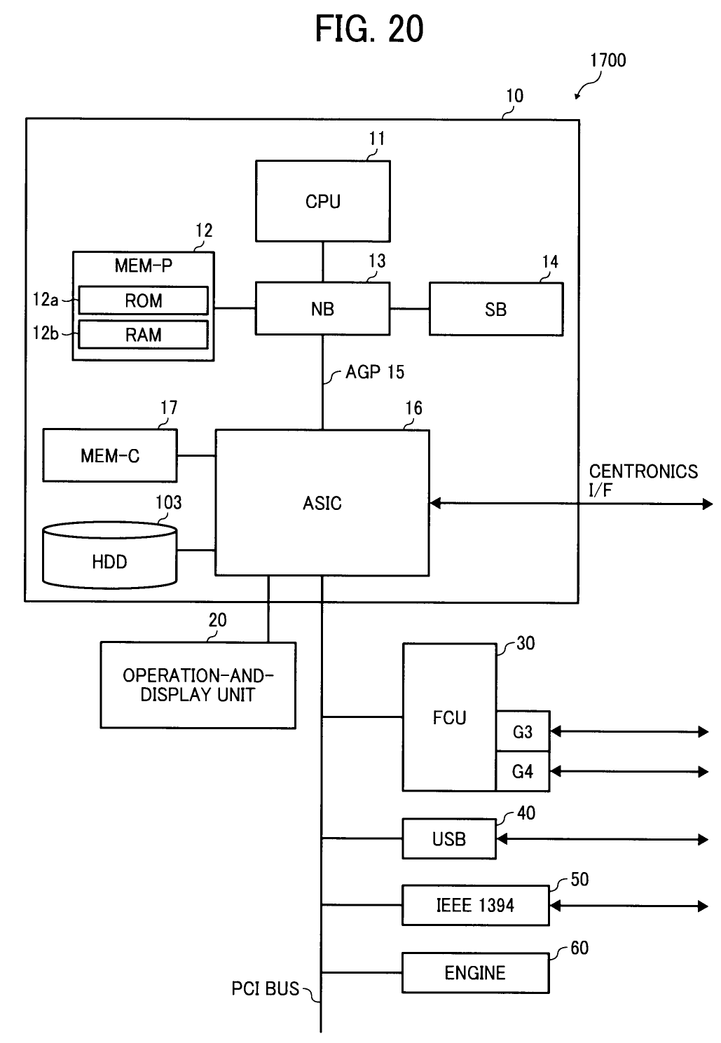

FIG. 20 is a block diagram illustrating a hardware configuration of the MFP 1700 according to the third embodiment. As illustrated in FIG. 20, the MFP 1700 includes a controller 10 and an engine 60 that are connected together with a peripheral component interface (PCI) bus. The controller 10 is a controller that controls the overall MFP 1700, rendering, communications, and input entered via an operating unit (not shown). The engine 60 is a printer engine or the like that is connectable to the PCI bus. Examples of the engine 60 include a monochrome plotter, a one-drum color plotter, a four-drum color plotter, a scanner, and a facsimile unit. The engine 60 includes, in addition to what is called an engine section such as the plotter, an image processing section that performs error diffusion, gamma conversion, and the like.

The controller 10 includes a central processing unit (CPU) 11, a north bridge (NB) 13, a system memory (hereinafter, “MEM-P”) 12, a south bridge (SB) 14, a local memory (hereinafter, “MEM-C”) 17, an application-specific integrated circuit (ASIC) 16, and the HDD 103, in which an accelerated graphics port (AGP) bus 15 connects between the NB 13 and the ASIC 16. The MEM-P 12 further includes a read only memory (ROM) 12a and a random access memory (RAM) 12b.

The CPU 11 controls the overall MFP 1700 and includes a chip set that includes the NB 13, the MEM-P 12, and the SB 14. The CPU 11 is connected to another device via the chip set.

The NB 13 is a bridge for connecting the CPU 11 to the MEM-P 12, the SB 14, and the AGP bus 15. The NB 13 includes a PCI master, an AGP target, and a memory controller that controls reading and writing from and to the MEM-P 12 and the like.

The MEM-P 12 that includes the ROM 12a and the RAM 12b is a system memory for use as a memory for storing program codes and data, a memory for loading program codes and data thereinto, a memory for use in rendering for the printer, and the like. The ROM 12a is a read only memory for use as a memory for storing program codes and data. The RAM 12b is a writable and readable memory for use as a memory for loading program codes and data thereinto, a memory for use in rendering for the printer, and the like.

The SB 14 is a bridge for connecting the NB 13 to a PCI device and peripheral devices. The SB 14 is connected to the NB 13 via the PCI bus, to which a network I/F and the like are also connected.

The ASIC 16, which is an integrated circuit (IC) for use in image processing, includes a hardware component for the image processing and functions as a bridge that connects the AGP bus 15, the PCI bus, the HDD 103, and the MEM-C 17 with each other. The ASIC 16 includes a PCI target and an AGP master, an arbiter (ARB) serving as the core for the ASIC 16, a memory controller that controls the MEM-C 17, a plurality of direct memory access controllers (DMACs) that performs data processing related to rotation of an image and the like by hardware logic, and a PCI unit that performs data transfer to and from the engine 60 via the PCI bus. A facsimile control unit (FCU) 30, a universal serial bus (USB) 40, and an IEEE 1394 I/F 50 are connected to the ASIC 16 via the PCI bus. An operation-and-display unit 20 is directly connected to the ASIC 16.

The MEM-C 17 is a local memory for use as a copy image buffer and a code buffer. The HDD 103 is a storage for storing therein image data, program codes, font data, and forms.

The AGP bus 15 is a bus interface for a graphics accelerator card introduced to speed up graphics operations and allows direct access to the MEM-P 12 with a high throughput, thereby speeding up operations related to the graphic accelerator card.

Installation program codes to be executed by the MFP 1700 is provided as being preinstalled in a ROM or the like.

The installation program codes to be executed by the MFP 1700 according to the third embodiment can be configured to be provided as being recorded in a computer-readable recording medium such as a compact disc-read-only memory (CD-ROM), a flexible disk (FD), a compact disc recordable (CD-R), or a digital versatile disk (DVD) in an installable or executable format.

The installation program codes to be executed by the MFP 1700 according to the third embodiment can be configured to be stored in a computer connected to a network, such as the Internet, so that the installation program codes are provided by downloading via the network. The installation program codes to be executed by the MFP 1700 according to the third embodiment can be configured to be provided or distributed via a network, such as the Internet.

The installation program codes to be executed by the MFP 1700 according to the third embodiment have a module structure that contains the application-installation control service 131. From the viewpoint of actual hardware, the CPU (processor) reads installation program codes from the ROM and executes the installation program to load the application-installation control service 131 on a main memory device, thereby generating the application-installation control service 131 on the main memory device.

Although the third embodiment has been described with regard to installation of an application onto the MFP 1700, this technique is applicable to software program other than the application.

The management apparatus 500, the software distribution server 400, the license management server 300, and the web server 600 according to the embodiments each has hardware configuration that utilizes a typical computer and includes a control device such as a CPU, a storage device such as a ROM and/or a RAM, an external storage device such as an HDD and/or a CD drive, a display device, and an input device such as a keyboard and/or a mouse.

Software-information extraction program and installation-request generating program to be executed by the management apparatus and software-information extraction program to be executed by the software distribution server according to the embodiments can be provided as being recorded in a computer-readable recording medium such as a CD-ROM, an FD, a CD-R, or a DVD in an installable or executable format.

The software-information extraction program and the installation-request generating program to be executed by the management apparatus and the software-information extraction program to be executed by the software distribution server according to the embodiments can be configured to be stored in a computer connected to a network, such as the Internet, so as to be provided by downloading via the network. The software-information extraction program and the installation-request generating program to be executed by the management apparatus and the software-information extraction program to be executed by the software distribution server according to the embodiments can be configured to be provided or distributed via a network, such as the Internet.

The software-information extraction program and the installation-request generating program to be executed by the management apparatus and the software-information extraction program to be executed by the software distribution server according to the embodiments can be configured to be provided as being installed in a ROM or the like in advance.

The software-information extraction program and the installation-request generating program to be executed by the management apparatus and the software-information extraction program to be executed by the software distribution server according to the embodiments have a module structure containing the units described above. From the viewpoint of actual hardware, the CPU (processor) reads the software-information extraction program and the installation-request generating program from the storage medium and executes the software-information extraction program and the installation-request generating program to load the units on a main memory device, thereby generating the units on the main memory device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A software management apparatus connected to a software distribution server that distributes a software component and to one or more image forming apparatuses via a network, the software management apparatus comprising:
a device-information receiving unit that receives from an external entity at predetermined timing, device information that contains installed-software information on a software component that has already been installed onto the image forming apparatus;
a device-information storing unit that stores therein the device information received by the device-information receiving unit;
a software-information obtaining unit that, when receiving a first installation request for installation of a software component onto an image forming apparatus specified by a user, obtains software information on the software component requested to be installed from the software distribution server;
a request generating unit that generates a second installation request for installation of the software component requested to be installed based on the software information on the software component requested to be installed and the device information on the specified image forming apparatus; and
a request transmitting unit that transmits the second installation request to the specified image forming apparatus so as to cause the software component, which is requested to be installed, to be installed onto the specified image forming apparatus.

2. The software management apparatus according to claim 1, further comprising a software-information extraction unit, wherein
the software information contains dependent-software information on a dependent software component that need to be installed onto an image forming apparatus prior to installation of the software component requested to be installed,
the software-information extraction unit
compares the dependent-software information with the installed-software information, and
extracts information on a not-installed dependent software component from the dependent-software information, wherein
the not-installed dependent software component is a dependent software component corresponding to the software component requested to be installed and is not installed onto the specified image forming apparatus yet, and
the request generating unit generates the second installation request so as to contain information on the software component requested to be installed and the information on the not-installed dependent software component.

3. The software management apparatus according to claim 2, wherein
the software information contains a data piece indicating a location, from which the to-be-installed software component is obtained, and a data piece indicating a location, from which the dependent software component is obtained, and
the request generating unit generates the second installation request so as to contain the data piece indicating the location of the to-be-installed software component, and the data piece indicating the location of the not-installed dependent software component.

4. The software management apparatus according to claim 1, wherein
the device-information receiving unit receives the device information from an intermediary apparatus,
the intermediary apparatus being connected to the image forming apparatus via the network, and upon receiving the second installation request from the software management apparatus, causing the software component, which is requested to be installed, to be installed onto the specified image forming apparatus,
the request generating unit generates the second installation request so as to contain identification of the specified image forming apparatus, and
the request transmitting unit transmits the second installation request generated by the request generating unit to the intermediary apparatus so as to cause the software component, which is requested to be installed, to be installed onto the image forming apparatus.

5. The software management apparatus according to claim 2, wherein
the device-information receiving unit receives the device information from an intermediary apparatus,
the intermediary apparatus being connected to the image forming apparatus via the network, and upon receiving the second installation request from the software management apparatus, causing the software component, which is requested to be installed, to be installed onto the specified image forming apparatus,
the request generating unit generates the second installation request so as to contain identification of the specified image forming apparatus, and
the request transmitting unit transmits the second installation request generated by the request generating unit to the intermediary apparatus so as to cause the software component, which is requested to be installed, to be installed onto the image forming apparatus.

6. The software management apparatus according to claim 1, wherein
the device-information receiving unit receives the device information from the one or more image forming apparatuses, and
a request transmitting unit transmits the second installation request to the specified image forming apparatus so as to cause the software component, which is requested to be installed, to be installed onto the specified image forming apparatus.

7. The software management apparatus according to claim 1, wherein
the software-information obtaining unit
transmits the installed-software information on the specified image forming apparatus to the software distribution server and
receives, from the software distribution server, the software information that contains information on the to-be-installed software component and information on a not-installed dependent software component, wherein
the not-installed dependent software component is not installed onto the specified image forming apparatus yet, and is a dependent software component that need to be installed onto an image forming apparatus prior to installation of the software component requested to be installed, and
the request generating unit generates the second installation request so as to contain the information on the software component, which is to be installed, and the information on the not-installed dependent software component.

8. A software distribution server that is connected to one or more image forming apparatuses and a software management apparatus that manages installation of a software component via a network, and that distributes a software component to one of the image forming apparatuses, the software distribution server comprising:
a software storing unit that stores therein the software component and software information on the software component;
a software-information-request receiving unit that receives an information request for software information on a software component requested to be installed from the software management apparatus;
a software-information extraction unit that extracts the software information on the software component requested to be installed from the software storing unit upon receiving the information request; and
a software-information transmitting unit that transmits the extracted software information on the software component requested to be installed to the software management apparatus.

9. The software distribution server according to claim 8, wherein
the software information contains dependent-software information on a dependent software component that need to be installed onto an image forming apparatus prior to installation of the to-be-installed software component,
the software-information-request receiving unit receives the information request that contains installed-software information on a software component that has already been installed onto a specified image forming apparatuses,
the software information extraction unit
compares the dependent-software information corresponding to the software component requested to be installed with the installed-software information, and
extracts information on a not-installed dependent software component from the dependent-software information, wherein
the not-installed dependent software component is a dependent software component corresponding to the software component requested to be installed and is not installed onto the specified image forming apparatus yet, and
the software-information transmitting unit transmits, to the software management apparatus, the software information that contains the extracted information on the not-installed dependent software component.

10. A software distribution system comprising:
one or more image forming apparatuses;
a software distribution server that distributes a software component to one or more of the image forming apparatuses; and
a software management apparatus that is connected to the image forming apparatuses and to the software distribution server via a network, and that manages installation of the software component, wherein
the image forming apparatus transmits, at predetermined timing to the software management apparatus, device information that contains installed-software information on a software component that has already been installed onto the image forming apparatus,
the software management apparatus includes:
a device-information receiving unit that receives the device information from the one or more image forming apparatuses;
a device-information storing unit that stores therein the received device information;
a software-information obtaining unit that,
when receiving a first installation request for installation of a software component onto an image forming apparatus specified by a user, transmits to the software distribution server an information request for software information on the software component requested to be installed and
receives the software information on the software component requested to be installed from the software distribution server;
a request generating unit that generates a second installation request for installation of the software component requested to be installed based on the software information on the software component, which is requested to be installed, and the device information on the specified image forming apparatus; and
a request transmitting unit that transmits the second installation request to the specified image forming apparatus so as to cause the software component, which is requested to be installed, to be installed onto the specified image forming apparatus, and
the software distribution server includes:
a software storing unit that stores therein the software component and software information on the software component;
a software-information-request receiving unit that receives the information request; and
a software-information transmitting unit that obtains from the software storing unit, the software information on the software component requested to be installed, which is specified in the information request, and transmits the obtained software information to the software management apparatus.
